(19) United States
(12) Patent Application Publication
(10) Pub. No.: US 2026/0213088 A1
(43) Pub. Date: Jul. 23, 2026

(54) ELECTRICAL CONTACTOR WITH AN INTEGRATED BREAKING DEVICE

(71) Applicant: SAFRAN ELECTRICAL & POWER, Blagnac (FR)

(72) Inventors: Edwin CALDERON, Blagnac (FR); Guillaume PRIEUR, Blagnac (FR); Kévin ENOUF, Blagnac (FR)

(73) Assignee: SAFRAN ELECTRICAL & POWER, Blagnac (FR)

(21) Appl. No.: 19/144,795

(22) PCT Filed: Jan. 10, 2024
(86) PCT No.: PCT/FR2024/050022

§ 371 Date: Jun. 30, 2025

(30) Foreign Application Priority Data
Jan. 13, 2023 (FR) FR2300347

(51) Int. Cl. H01H 9/36; H01H 9/54; H01H 47/00

(52) U.S. Cl. CPC H01H 9/36; H01H 9/54; H01H 47/002

(57) ABSTRACT

An electrical contactor with a built-in breaking device, including at least one arc breaking device including a first guide, a second guide connected to the contact, and a finned breaking module including a succession of conductive fins extending between the first guide and the second guide. The arc breaking device includes a controlled switch connected between two conductive fins of the finned breaking module and controlled by an electronic control unit.

### TECHNICAL FIELD

The invention relates to an item of electrical protection equipment, and more specifically a contactor and electrical current circuit breaker intended to be installed in an electrical circuit, for example of an aircraft.

### PRIOR ART

FIGS. 1 to 5 schematically represent different section views of an electrical contactor 1 of the prior art.

The electrical contactor 1 of the prior art comprises two electrically separate fixed electrical contacts 2, a movable bridge 3, and one arc breaking device 4 for each fixed electrical contact 2, or two arc breaking devices 4.

Each arc breaking device 4 includes a first arc guide 5, a second arc guide 6 electrically connected to the fixed electrical contact 2 with which the arc breaking device is associated, and a finned breaking module 7 extending between the first arc guide 5 and the second arc guide 6, at a distance from the movable bridge 3 and from the associated fixed electrical contact 2.

The two first arc guides 5 of the two arc breaking devices 4 are electrically coupled together. And each finned breaking module 7 comprises a series of fins 8 successively disposed on top of one another between the second arc guide 6 and the first arc guide 5, each fin 8 being spaced apart from the other fins by an empty space. The fin 8 at the top of the stack is separated from the first arc guide 5 by an empty space, and the fin at the base of the stack is separated from the second arc guide 6 by an empty space.

The movable bridge 3 is movable between a first position and a second position.

In the first position illustrated on FIG. 1, the movable bridge 3 is mechanically and electrically in contact with the two fixed electrical contacts 2 and at a distance from the two first arc guides 5, and a second position in contact with the first arc guides 5 and at a distance from the fixed electrical contacts 2.

In this first position, the two fixed electrical contacts 2 are electrically connected via the movable bridge 3, thus allowing the electrical current to flow from one fixed electrical contact 2 to the other via the movable bridge 3 as illustrated by the arrows 9 in dash-dotted lines.

In the second position illustrated on FIG. 2, the movable bridge 3 is mechanically separated by two fixed electrical contacts 2 and mechanically and electrically in contact with the two first arc guides 5.

In this second position, the two fixed electrical contacts 2 are electrically decoupled one from the other, and no current can normally flow from one fixed electrical contact 2 to the other.

However, during the separation of the movable bridge 3 with the two fixed electrical contacts 2, an electric arc A can form by ionization of the arc at each of the two places of separation as illustrated on FIG. 3. An electrical current 9 then always flows from one fixed electrical contact 2 to the other via the movable bridge 3 as illustrated by the arrows in dash-dotted lines.

As illustrated on FIGS. 4 and 5, the electric arcs A will then move outward via the first arc guides 5 and the second arc guides 6 owing to the Laplace force which is created between the electrical current 9 and the magnetic field 11. The electric arcs A, under the effect of the magnetic field 11 created by permanent magnets, bend and then lick the first and second arc guides 5 and 6.

As illustrated on FIG. 6, the electric arcs A thus move all the way into the finned breaking modules 7. Once the electric arcs A have entered the fins 8 of the finned breaking module 7, the arc will split into multiple arcs which will make the current drop to zero and cause the breaking of the network, i.e. the opening of the electrical circuit between the two fixed electrical contacts 2.

This arc phenomenon is dependent on the properties of the air at the time of its creation (pressure and temperature) and is greatly affected by the altitude when the breaking device is in ambient air. Depending on the geometry and the environmental conditions or the level of current, it is then possible that the arc will overshoot the fins 8 of the finned breaking module 7 and that the electric arc will cross them and come out on the other side. Since the arc has not been broken in the fins 8, it then completely reforms and will not be extinguished as illustrated on FIG. 7.

Since an electric arc A is a plasma which can reach several thousands of degrees Celsius, if it is sustained for too long, it can damage the rest of the electrical contactor and potentially propagate.

There is therefore a need for an additional protection system making it possible to contain and/or limit the propagation of electric arcs.

The use of an electronic switch of SSPC type, i.e. a semi-conductor power converter, makes it possible to break an electrical current without creating any arc and with a much larger number of opening cycles by comparison with an electromechanical contactor. SSPCs can be considered as a beneficial option for aerospace applications.

However, this type of switch has very high conduction losses which must therefore be cooled with a large heat sink or dedicated fluid cooling circuit which is also bulky to install and does not allow any electrical insulation by a genuine physical separation of the electrical conductors in the event of a malfunction.

The hybridization concept makes it possible to optimize the capabilities of an electromechanical contactor while very significantly reducing the presence of arcs between the contacts. To do this, a electromechanical contactor (main branch) is set up in parallel with electronic components (secondary branch). In general two topologies are commonly used in the secondary branch. The first is based on the use of a switching device (IGBT, MOSFET, THYRISTOR, etc.) and the second based on the use of a bank of capacitors which produces a reverse current to that of the main branch.

Such devices are known from the documents U.S. Pat. No. 8,638,531, US 2018/0082814 and US 2018/0350533.

However, these types are still quite complex and heavy since each one is dimensioned for the nominal power level, which to some extent combines the drawbacks of the two technologies, and they are difficult to implement in a high-voltage direct-current (HVDC) electrical distribution system of an aircraft due to their dimensions and non-uniform form factors.

### SUMMARY OF THE INVENTION

The invention aims to supply a technical solution offering an electrical contactor capable of containing electric arcs to avoid their external propagation and thus to suppress them to guarantee mechanical and electrical insulation.

In a first subject of the invention, provision is made for an electrical contactor with a built-in electrical breaking device, said electrical contactor comprising at least one arc breaking device including a first arc guide, a second arc guide, and a finned breaking module including a succession of conductive fins extending between the first arc guide and the second arc guide.

According to a general feature of the invention, the arc breaking device further includes a controlled switch connected between two conductive fins of the finned breaking module and controlled by an electronic control unit.

The controlled switch coupled between two conductive fins of the module makes it possible to artificially generate a gradual increase of the voltage drop at the conductive fins. Once the arc has formed, the controlled switch is closed to allow the current flowing through the electric arc to be diverted into the controlled switch for a period of time and thus split the plasma of the electric arc between the two fins coupled to the controlled switch. Next, the controlled switch is opened again to artificially generate an additional voltage drop of short duration. The breaking of the plasma has caused a reduction in the free electrons between the conductive fins coupled to the controlled switch, increasing the voltage and rendering the formation of a plasma and its sustenance more complicated.

The electrical contactor according to the invention thus acts as a protection which makes it possible to benefit from the advantages of a conventional mechanical contactor which allows the discharging of energy and the cooling of the arc.

In a first embodiment of the electrical contactor according to the invention, the two conductive fins electrically connected to the controlled switch can be two successive conductive fins, no other conductive fin being disposed between said two successive fins.

The voltage between two successive conductive fins is generally at a maximum of 40 V. These low electrical requirements make it possible to use an IGBT of small size, and therefore of small size without needing any parallel circuit for overvoltage protection.

In addition, the cooling system which is normally used in hybrid topologies is not necessary since the product of the amperage of the current by the conduction time remains small.

In a second embodiment of the electrical contactor according to the invention, said finned breaking module of said at least one breaking device may comprise an insulating plate disposed between said two conductive fins to which the controlled switch is connected, the insulating plate having, in a plane orthogonal to a direction of stacking of the conductive fins, dimensions greater than or equal to the dimensions of the conductive fins between which it is disposed, and the insulating plate and the two conductive fins between which it is disposed being centered on the axis of stacking of the conductive fins.

The introduction of an insulating plate between the two conductive fins coupled to the controlled switch makes it possible to increase the resistance of the arc column by lengthening the path the arc must travel to form. Its dimensions and its position with respect to the conductive fins between which it is disposed make it possible to ensure that no portion of one of the two conductive fins is directly facing the other conductive fin. This makes it possible to ensure that the path for the arc to travel is longer and therefore to increase the electrical resistance.

In a third embodiment of the electrical contactor according to the invention, the electronic control unit may comprise a detection unit electrically connected to said two conductive fins connected to the controlled switch, and a trigger unit electrically connected to the controlled switch, the detection unit being configured to measure the voltage across the terminals of the two conductive fins connected to the controlled switch and generate an activation signal to the trigger unit when the measured voltage is greater than a voltage threshold, and the trigger unit being configured to generate a signal of closing of the controlled switch for a given fixed period following the reception of an activation signal.

Preferably, the controlled switch is an insulated-gate bipolar transistor.

An insulated-gate bipolar transistor (IGBT) is capable of conducting high arc currents but for a short period of time.

In a fourth embodiment of the electrical contactor according to the invention, the electrical contactor with built-in electrical breaking device comprises at least two electrically separate fixed electrical contacts, a movable bridge, and an arc breaking device for each fixed contact, each arc breaking device including a first arc guide, a second arc guide electrically connected to the associated fixed contact, and a finned breaking module extending between the first arc guide and the second arc guide, distant from the movable bridge and from the associated fixed contact, the first arc guides of the different arc breaking devices being electrically coupled together, and the movable bridge being movable between a first position in contact with said fixed contacts and at a distance from the first arc guides, and a second position in contact with the first arc guides and at a distance from said fixed contacts.

In another subject of the invention, provision is made for an electrical distribution system for an aircraft characterized in that it comprises at least one electrical contactor as defined above.

In another subject of the invention, provision is made for an aircraft comprising an electrical distribution system as defined above.

### BRIEF DESCRIPTION OF THE DRAWINGS

The invention will be better understood on reading the text below, given for information purposes but non-limiting, with reference to the appended drawings on which:

FIG. 1, already described, schematically represents a section view of an electrical contactor 1 of the prior art in a first position.

FIG. 2, already described, schematically represents a section view of the electrical contactor 1 of the prior art in a second position.

FIG. 3, already described, schematically represents a section view of the electrical contactor 1 of the prior art of FIG. 2 with the appearance of electric arcs.

FIG. 4, already described, schematically represents a section view of the electrical contactor 1 of the prior art of FIG. 2 with the electric arcs moving outward.

FIG. 5, already described, schematically represents a section view of the electrical contactor 1 of the prior art of FIG. 2 with the electric arcs further outward.

FIG. 6, already described, schematically represents a section view of the electrical contactor 1 of the prior art of FIG. 2 with the electric arcs moved into the finned breaking module.

FIG. 7, already described, schematically represents a section view of the electrical contactor 1 of the prior art of FIG. 2 with the electric arcs outside the finned breaking module.

FIG. 8 schematically represents a section view of an electrical contactor 10 according to an embodiment of the invention in a first position.

FIG. 9 schematically represents a section view of the electrical contactor 10 of FIG. 8 in a second position.

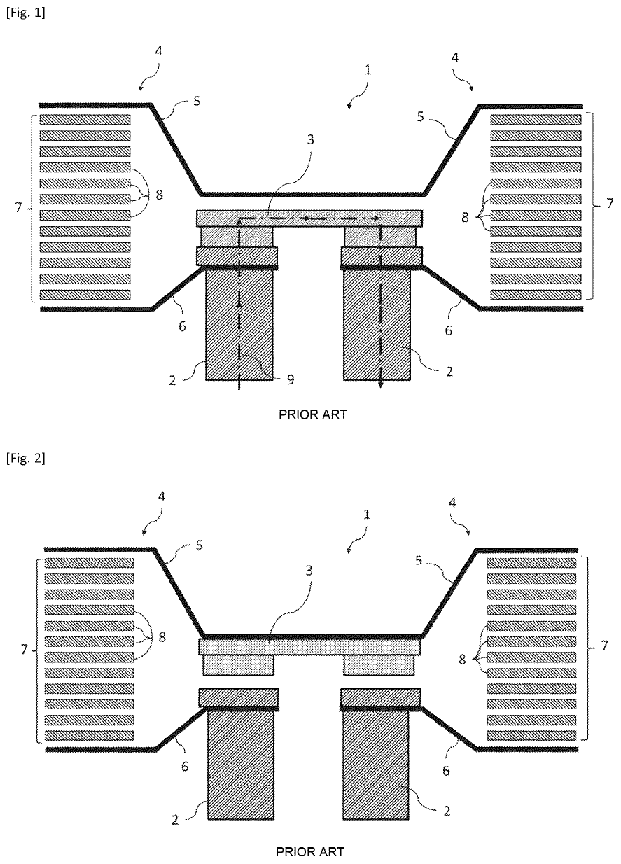

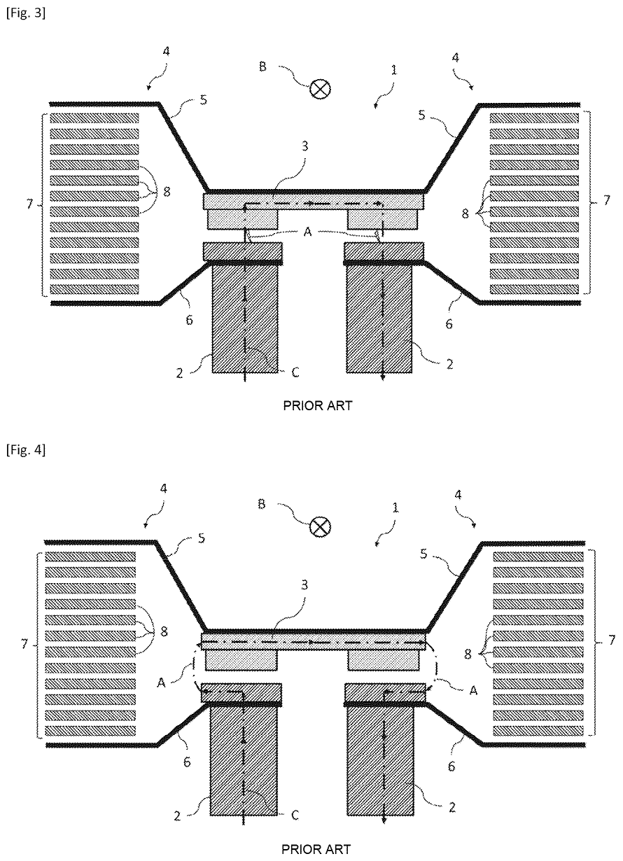

### DESCRIPTION OF THE EMBODIMENTS

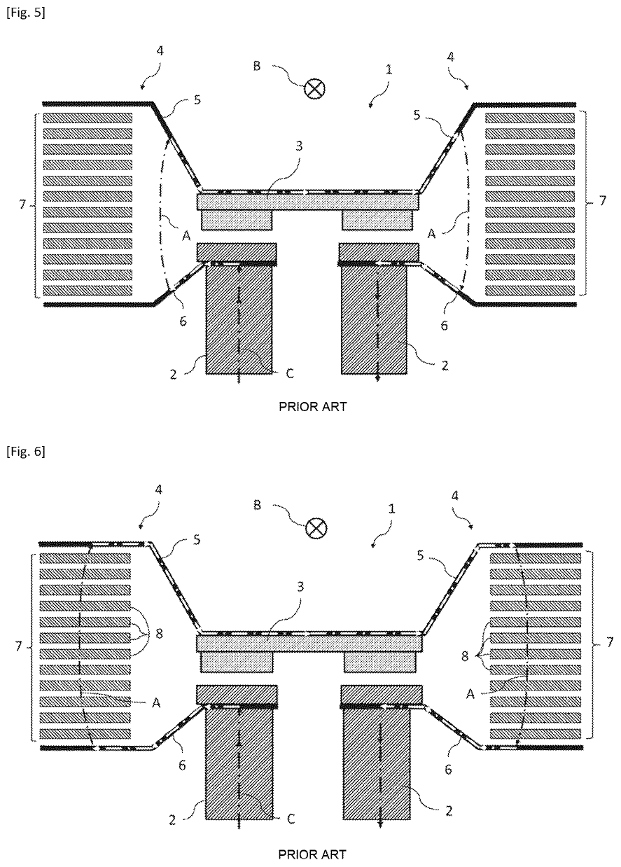

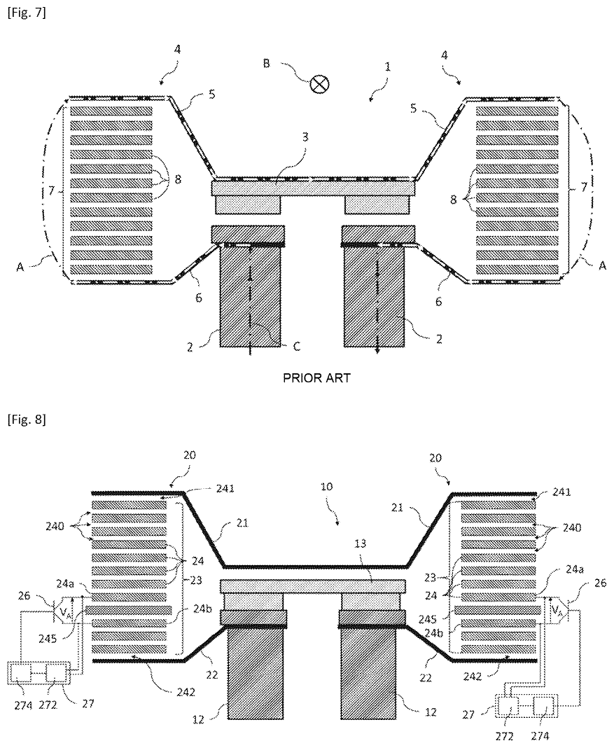

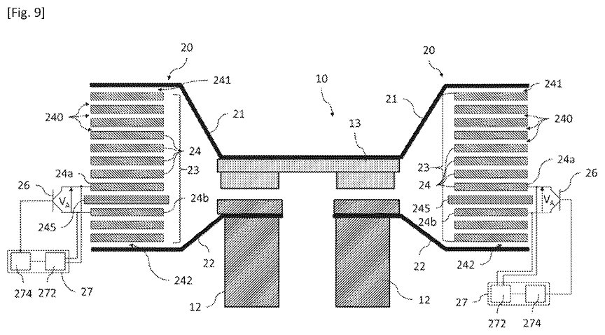

FIG. 8 schematically represents a section view of an electrical contactor 10 with a built-in electrical breaking device according to an embodiment of the invention.

In the embodiment illustrated on FIG. 8, the electrical contactor 10 comprises two fixed electrical contacts 12 which are electrically separate, a movable bridge 13, and, for each fixed contact 12, an arc breaking device 20, in other words two arc breaking devices 20.

As illustrated on FIGS. 8 and 9, the movable bridge 13 is movable between a first position illustrated on FIG. 8, in which the movable bridge 13 is in contact with the fixed contacts 12 and at a distance from the first arc guides 21, and a second position, illustrated on FIG. 9, in which the movable bridge 13 is in contact with the first arc guides 13 and at a distance from the fixed contacts 12. In the first position, the current flows from a fixed contact 12 to the other fixed contact 12 via the movable bridge 13. In the second position, no current is intended to flow from one fixed contact to the other, unless an electric arc forms between the movable bridge and a fixed contact 12.

As illustrated on FIGS. 8 and 9, each arc breaking device 20 includes a first arc guide 21, a second arc guide 22 electrically connected to the associated fixed contact 12, and a finned breaking module 23 including a plurality of electrically conductive fins 24 and extending between the first arc guide 21 and the second arc guide 22. The finned breaking module 23 is disposed at a distance from the movable bridge 13 and from the adjacent fixed contact 12.

The first arc guides 21 of the two arc breaking devices 20 are electrically coupled together.

The fins 24 of a finned breaking module 23 are successively superimposed on top of one another between the second arc guide 22 and the first arc guide 21. The finned breaking module 23 thus comprises a stack of a plurality of conductive fins 24. Each fin 24 is separated from another fin 24 by an empty gap 240, and is therefore not in electrical contact with another fin 24. The fin 24 at the top of the superposition is separated from the first arc guide 21 by a top empty gap 241, and the fin at the base of the superimposition is separated from the second arc guide 21 by another base empty gap 242.

Each arc breaking device 20 further comprises an insulating plate 245 disposed between two successive conductive fins 24. The plate 245 is electrically insulating and has dimensions greater than the dimensions of the fins 24 in a plane orthogonal to the direction of stacking of the fins 24. The successive conductive fins between which the insulating plate 245 is disposed are written 24a and 24b on FIGS. 8 and 9.

Each arc breaking device 20 also comprises an electrical protection circuit 25 comprising a controlled switch 26, here an IGBT, and a control unit 27 comprising a detection unit 272 and a trigger unit 274.

The detection unit 272 is electrically connected to the two fins 24a and 24b disposed facing the insulating plate 245. The first 24a of these two fins is coupled to the collector of the IGBT 26, while the second 24b is coupled to the emitter of the IGBT 26.

The trigger unit 274 is coupled at the input to the detection unit 272 and at the output to the gate of the IGBT 26 to control the opening or closing of the IGBT as a function of the voltage measured across the terminals of the fins 24a and 24b coupled to the IGBT.

The detection unit 272 is configured to measure the voltage across the terminals of the two conductive fins 24a and 24b connected to the IGBT 26 and to generate an activation signal to the trigger unit 274 when the voltage measured between the two fins 24a and 24b is greater than a voltage threshold.

The trigger unit 274 is configured to generate a signal of closing of the IGBT 26 for a given fixed period following the reception of an activation signal from the detection unit 272.

The detection unit 272 is configured to constantly measure the voltage VA between the fins 24a and 24b separated by the insulating plate 245, in other words to measure the voltage VA across the terminals of the IGBT 26. If the voltage VA across the terminals of the IGBT 26 is greater than a threshold voltage, the detection unit 272 delivers an activation signal to the trigger unit 274 which in response generates a closing signal to the gate of the IGBT 26.

The closing signal delivered to the gate of the IGBT 26 by the trigger unit 274 is a positive square wave signal. The amplitude and the period of the positive square wave of the trigger signal are fixed. The closing time, i.e. the period of the square wave, depends on the size and characteristics of the controlled switch 26 used.

The conduction path of the IGBT 26 generated by the closing of the gate of the IGBT 26 makes it possible to switch from the current of the arc of the ionized air between the fins 24a and 24b to the collector-emitter junction of the IGBT 26.

This diverting of the arc between the fins 24a and 24b toward the IGBT 26 gives rise to the extinguishing of the plasma between the conductive fins 24a and 24b. Thus, the overall column of plasma is split into two parts: a first section of the plasma extending between the upper guide 21 and the fin 24a connected to the collector of the IGBT 26 passing via the different conductive fins 24 located between these two elements, and a second section of plasma caught on the fin 24b connected to the emitter of the IGBT 26 and to the lower guide 22 passing via the different conductive fins 24 located between these two elements.

The following step in the breaking of the current is the causing of a significant increase in the voltage drop at the fins. However, at altitude, a mechanism based on voltage drops in the fins remains low enough to break the current optimally. One thus artificially generates an additional voltage drop of short duration caused by the blocking of the passage of the current via the IGBT 26, i.e. the opening of the controlled switch 26, after the preceding conduction period. Thus, the arc roots of the first section and of the second section of plasma present on the fins 24a are 24b destabilized by the untimely opposing of the current.

This leads to a reduction in the free electrons for sustaining the plasma, thus, the overall voltage at the fins 24a and 24b increases and the current is broken.

The invention thus provides a technical solution offering an electrical contactor capable of containing electric arcs to avoid them propagating outside, and thus suppressing them in order to guarantee mechanical and electrical insulation.

1. An electrical contactor with a built-in electrical breaking device, said electrical contactor comprising at least one arc breaking device including a first arc guide a second arc guide and a finned breaking module including a succession of conductive fins-extending between the first arc guide and the second arc guide, wherein the arc breaking device further includes a controlled switch connected between two conductive fins of the finned breaking module and controlled by an electronic control unit the two conductive fins electrically connected to the controlled switch being two successive conductive fins, no other conductive fin being disposed between said two successive fins.

2. The electrical contactor as claimed in claim 1, wherein said finned breaking module of said at least one breaking device comprises an insulating plate disposed between said two conductive fins to which the controlled switch is connected, the insulating plate having, in a plane orthogonal to a direction of stacking of the conductive fins, dimensions greater than or equal to the dimensions of the conductive fins between which it is disposed, and the insulating plate and the two conductive fins between which it is disposed being centered on the axis of stacking of the conductive fins.

3. The electrical contactor as claimed in one of claim 1, wherein the electronic control unit comprises a detection unit electrically connected to said two conductive fins connected to the controlled switch and a trigger unit electrically connected to the controlled switch, the detection unit being configured to measure the voltage across the terminals of the two conductive fins connected to the controlled switch and generate an activation signal to the trigger unit when the measured voltage is greater than a voltage threshold, and the trigger unit being configured to generate a signal of closing of the controlled switch for a given fixed period following the reception of an activation signal.

4. The electrical contactor as claimed in claim 1, wherein the controlled switch is an insulated-gate bipolar transistor.

5. The electrical contactor as claimed in claim 1, comprising at least two fixed electrical contacts that are electrically separate and each connected to a separate second arc guide, a movable bridge and an arc breaking device for each fixed contact, the finned breaking module of each arc breaking device being disposed at a distance from the movable bridge and from the associated fixed contact, the first arc guides of the different arc breaking devices being electrically coupled together, and the movable bridge being movable between a first position in contact with said fixed contacts and at a distance from the first arc guides and a second position in contact with the first arc guides and at a distance from said fixed contacts.

6. An electrical distribution system for an aircraft wherein it comprises at least one electrical contactor as claimed in claim 1.

7. An aircraft comprising an electrical distribution system as claimed in claim 6.
